(19) United States
(12) Patent Application Publication
(10) Pub. No.: US 2007/0015055 A1
(43) Pub. Date: Jan. 18, 2007

(54) Cathode active material comprising additive for improving overdischarge-performance and lithium secondary battery using the same

(76) Inventors: Jae Hyun Lee, Daejeon (KR); Min Chul Jang, Gyeonggi-do (KR); Duk Hyun Ryu, Daejeon (KR); Jun Yong Jeong, Daejeon (KR); Han Ho Lee, Daejeon (KR); Soon Ho Ahn, Daejeon (KR)

Correspondence Address: CANTOR COLBURN, LLP, 55 GRIFFIN ROAD SOUTH, BLOOMFIELD, CT, 06002, US

(21) Appl. No.: 10/552,529

(22) PCT Filed: Apr. 6, 2004
(86) PCT No.: PCT/KR04/00786

§ 371 Date: Oct. 11, 2005

(30) Foreign Application Priority Data
Apr. 9, 2003 (KR) 10-2003-0022429

(51) Int. Cl. H01M 4/48; H01M 4/50; H01M 4/52

(52) U.S. Cl. 429/231.1; 429/224; 429/223; 429/231.3; 429/338; 429/337; 429/342

(57) ABSTRACT

Disclosed is a cathode active material providing a cell performance that is not adversely affected by overdischarge, and a lithium secondary cell using the same. More particularly, the cathode active material for a lithium secondary cell comprises a lithium-transition metal oxide capable of lithium ion intercalation/deintercalation, wherein the cathode active material further comprises a lithium manganese oxide having a layered structure represented by the following formula 1 as an additive:[formula 1] LiMₓMn₁₋ₓ0₂ wherein, x is a number satisfying 0.05 x<0.5, and M is at least one metal selected from the group consisting of Cr, Al, Ni, Mn and Co. The lithium manganese oxide of formula 1 used as an additive for a cathode active material of a lithium secondary cell provides lithium ions in such an amount as to compensate for an irreversible lithium ion-consuming reaction at an anode, or more, thereby providing a lithium secondary cell which is low in capacity loss by over-discharge.

### TECHNICAL FIELD

The present invention relates to a lithium secondary cell, the capacity of which is not significantly reduced after over-discharge and the capacity restorability of which after over-discharge is excellent, and more particularly, to a cathode active material comprising a lithium manganese oxide (LiMₓMn₁₋ₓO₂) having a layered structure as a cathode additive for improving over-discharge property, and a lithium secondary cell obtained by using the same.

### BACKGROUND ART

Recently, as mobile communication industries and information electronic industries progress in various technologies, a light-weight lithium secondary cell having a high capacity is increasingly in demand. However, a lithium secondary cell may ignite and explode due to extreme heat emission, when it is over-charged or is in a short circuit state. Moreover, when a lithium secondary cell is over-discharged below a normal voltage range, its capacity is rapidly reduced so that it may not be used any more.

For these reasons, a safety device like a protection circuit, a PTC, etc., has been attached to a lithium secondary cell since lithium secondary cells were first developed. However, such protection circuits, PTCs, etc., are not preferable, because they are expensive and take up a large volume, thereby increasing the price, volume and weight of the cell. Therefore, developments for a cell having a reduced manufacturing cost and an increased cell capacity without using such a protection circuit, PTC, etc., are very much in demand.

Conventionally, an organic or an inorganic additive is used in a non-aqueous electrolyte solution, or the outer structure of a cell is changed for the purpose of ensuring the cell safety when a cell is over-charged or is in a short circuit state. However, in the case that a cell is over-discharged below an adequate voltage, even if one tries to charge the cell again, the cell capacity is so rapidly reduced that charge/discharge of the cell may not be accomplished any more.

Conventional lithium secondary cells developed up to date have a structure in which discharge is limited and terminated by an anode in the case of over-discharge. Particularly, when a non-aqueous lithium secondary cell is first charged, a solid electrolyte interface (SEI) film is formed on the surface of an anode. In this case, a great amount of lithium ions released from a cathode are used, and thus the amount of Li participating in charge/discharge is reduced. When over-discharging occurs in the state in which the amount of Li is reduced, activated Li sites in the cathode are not fully occupied and the cathode voltage is not decreased below a certain voltage. Therefore, discharge is terminated by the anode (see FIG. 7).

Meanwhile, a cell capacity is rapidly reduced by the following reasons. A cell voltage is defined by a difference of a cathode voltage and an anode voltage. Additionally, when a cell is continuously discharged at a low electric current, even after the cell voltage is decreased below a general-use voltage, the cathode voltage is not decreased any more due to the consumption of Li in the anode, and thus it is slowly decreased. On the other hand, the anode voltage is rapidly increased and eventually it is raised to 3.6 V, at which point a copper foil used as an anode collector is oxidized. Thus, the copper foil is dissolved in a copper ion state, contaminating electrolytes, is attached again to the surface of the anode during re-charge, and thus the anode active material becomes unusable. Therefore, when the oxidization of the copper foil occurs, the cell capacity is rapidly reduced after over-discharge, so that the cell becomes unusable.

Accordingly, it is desirable to develop a cell in which the cell discharge is limited by a cathode, so that the cell capacity may not be significantly reduced after over-discharge, and a new method for making such a cathode-limited cell is very much in demand.

Meanwhile, when a lithium manganese oxide is used as a cathode active material, a spinel-structured lithium manganese oxide is generally used for the purpose of improving the thermal stability of a cathode. This provides an advantage of a low cost and a simple synthetic procedure. However, the cell using a spinel-structured lithium manganese oxide as a cathode active material has problems that the capacity is low, the cell life may be reduced by side reactions, the high-temperature property is poor and the conductivity is also low. In order to solve these problems, many attempts to use a spinel-structured lithium manganese oxide partially substituted with other metals have been made. Korean Unexamined Patent Publication No. 2002-65191 discloses a spinel-structured lithium manganese oxide having excellent thermal stability, however, it provides a low capacity and cannot improve the over-discharge preventing capability.

In order to solve the problem of the low capacity in the spinel and to ensure excellent thermal stability of a manganese-based active material, many attempts to use a lithium manganese oxide having a layered structure have been made. In this case, the layered structure is unstable, and thus a phase transition occurs during charge/discharge, the cell capacity is rapidly reduced and the cell life is decreased. To solve these problems, methods for maintaining the structural stability by doping or substituting with other metals have been suggested. Particularly, Korean Unexamined Patent Publication No. 2002-24520 discloses a cell, in which a lithium manganese oxide having a layered structure is used as a cathode active material having excellent thermal stability, and a phase transition is prevented during charge/discharge so that the cell life can be improved. However, the over-discharge preventing capability cannot be improved in this case.

### DISCLOSURE OF THE INVENTION

The present inventors tried to develop a cell, in which by using a lithium manganese oxide having a layered structure, the cell discharge is limited by a cathode, so that the cell capacity may not be significantly reduced after over-discharge.

We found that, when a lithium manganese oxide having a layered structure is used as an additive for a cathode active material, a phase transition from a layered structure to a spinel structure in the lithium manganese oxide controls irreversible reactions in a cathode and an anode, and thus the cell capacity is not significantly reduced after over-discharge.

Therefore, the present invention has been made based on the foregoing, and it is an object of the present invention to provide a cathode active material for a lithium secondary cell comprising a lithium manganese oxide having a layered structure as an additive for a cathode, and a lithium secondary cell obtained by using the same.

According to an aspect of the present invention, there is provided a cathode active material for a lithium secondary cell comprising a lithium-transition metal oxide capable of lithium ion intercalation/deintercalation, characterized by further comprising a lithium manganese oxide having a layered structure represented by the following formula 1 as an additive:
LiMₓMn₁₋ₓO₂ [formula 1]
wherein, x is a number satisfying 0.05≦x<0.5, and M is at least one metal selected from the group consisting of Cr, Al, Ni, Mn and Co.

There is also provided a lithium secondary cell obtained by using the said cathode active material.

The lithium secondary cell according to the present invention comprises: (a) a cathode comprising the said cathode active material according to the present invention, (b) an anode, (c) a separator, and (d) a non-aqueous electrolyte solution containing a lithium salt and an electrolyte compound.

The present invention will be explained in detail hereinafter.

The lithium manganese oxide used as an additive for a cathode active material according to the present invention is represented by the following formula 1 and has a layered structure:
LiMₓMn₁₋ₓO₂ [formula 1].
wherein, x is a number satisfying 0.05≦x<0.5, and M is at least one metal selected from the group consisting of Cr, Al, Ni, Mn and Co.

The lithium manganese oxide of formula 1 (LiMₓMn₁₋ₓO₂) has a layered monoclinic, orthorhombic or hexagonal structure, and can be prepared by mixing lithium carbonate (Li₂CO₃), manganese oxide (Mn₂O₃) and a metal oxide in solid phases and heat-treating the mixture at a high temperature under argon atmosphere.

The lithium manganese oxide of formula 1 can act as a cathode active material, in which a structural change into a spinel structure represented by the following formula 2 occurs, when a cell is charged/discharged first:
LiM₂ₓMn₂₋₂ₓO₄ [formula 2]
wherein, x is a number satisfying 0.05≦x<0.5, and M is at least one metal selected from the group consisting of Cr, Al, Ni, Mn and Co.

The lithium manganese oxide of formula P having a layered structure is shown in FIG. 1, and the lithium manganese oxide of formula 2 having a spinel structure is shown in FIG. 2.

The lithium manganese oxide of formula 1 having a layered structure deintercalates one mole of lithium per two oxygen atoms during the first charge, however, after the first charge/discharge cycle, due to the structural change into a spinel structure, it becomes a substance capable of lithium intercalation/deintercalation in the ratio of 0.5 mole of lithium per two oxygen atoms.

Accordingly, when the lithium manganese oxide of formula 1 having a layered structure is used in a cathode as an additive for a cathode active material, the cathode active material composition according to the present invention shows a large difference between initial charge capacity and initial discharge capacity. This irreversible capacity provides lithium ions in such an amount as to compensate for an irreversible lithium consumption reaction in an anode caused by the SEI film formation on the surface of the anode during the first charge, or more. Therefore, such amount of lithium ions may compensate for the high and irreversible capacity of the anode at the first charge/discharge cycle.

In addition, the cathode active material composition according to the present invention, which comprises a lithium-transition metal oxide capable of lithium ion intercalation/deintercalation and the lithium manganese oxide of formula 1 having a layered structure can inhibit the capacity reduction caused by over-discharge, due to the irreversibility of the lithium manganese oxide of formula 1 during the first charge/discharge cycle. This mechanism is shown in FIG. 7.

A cell voltage is defined by the difference of electric potentials between a cathode and an anode. Over-discharge of a cell continuously proceeds until the cell voltage becomes 0 V, at which point the electric potentials of a cathode and an anode are the same.

As mentioned above, in general, the voltage of an anode having a relatively high irreversible capacity increases rapidly, when an over-discharge occurs, and thus copper ions are dissolved from an anode collector, so that charge/discharge cycles may not progress successfully. In order to prevent the increase of the voltage in the anode during an over-discharge, it is desirable to increase the irreversible capacity of the cathode so as to decrease the voltage of the cathode rapidly. For the purpose of increasing the irreversible capacity of the cathode, the present invention adopted a method that an additive having a high irreversible capacity is added to a cathode.

In the above formula 1, x is a number satisfying 0.05≦x<0.5, preferably 0.05≦x<0.2. If x is less than 0.05, a side reaction such as manganese ion dissolution may be generated, while if x is 0.5 or more, a phase transition from a layered structure to a spinel structure does not occur in a charge/discharge cycle, and thus it is not possible to improve the over-discharge property.

In the above formula 1, M is selected from the group consisting of Cr, Al, Ni, Mn and Co, and functions as a structure stabilizer. Preferably, M is Cr or Al. If M is Cr or Al, the structure of formula 1 is more stabilized, and provides excellent high-temperature life and high-temperature shelf property.

Most preferably, the lithium manganese oxide of formula 1 is LiCr_{0.1}Mn_{0.9}O₂.

The lithium manganese oxide of formula 1 (LiMₓMn₁₋ₓO₂) is preferably added in an amount of 1 to 50 parts by weight based on 100 parts by weight of a transition metal oxide. When the content of the lithium manganese oxide of formula 1 is less than 1 part by weight, it is not possible to solve the problem in the anode, such as copper ion dissolution. Additionally, when the said content is more than 50 parts by weight, the voltage of the cathode is decreased rapidly during an over-discharge test, so that reduction of an electrolyte may occur in the surface of the cathode and the cell capacity may be decreased. Therefore, in order to solve both problems in the cathode and the anode, the cathode potential preferably ranges from 2 V to 3.6 V and the anode potential preferably 3.6 V or less, when the full cell voltage becomes 0 V.

As described above, when the compound of formula 1 according to the present invention, preferably LiCr_{0.1}Mn_{0.9}O₂, is added to a cathode of a cell comprising an anode active material having an irreversible capacity of 30% or less, as an additive for a cathode active material, it is possible to obtain a capacity restorability of 90% or more after an over-discharge test and to prevent the decrease of the cell capacity. When the irreversible capacity of the anode active material is more than 30%, the cell capacity is reduced, and thus the compound of formula 1 must be added to the cathode in an amount of 50 wt % or more of the cathode active material. Such an excessive addition of the compound of formula 1 may cause other problematic side reactions, the deterioration of life characteristics and cell capacity reduction.

In addition, according to the present invention, if the compound of formula 1 is added to the cathode to the extent of compensating for the irreversible capacity of the anode, it is possible to obtain very excellent performance in an over-discharge test of a SCF (safety circuit free) cell, which does not need a protection circuit and is of interest to cell production companies recently.

The cathode active material used in the present invention is any one of general cathode active materials, however, it is preferable to use a lithium-transition metal oxide. For example, at least one lithium-transition metal oxide selected from the group consisting of LiCoO₂, LiNiO₂, LiMnO₂, LiMn₂O₄, Li(NiₐCo_{b}Mn_{c})O₂(0<a<1, 0<b<1, 0<c<1, a+b+c=1), LiNi_{1-d}CO_{d}O₂, LiCo_{1-d}Mn_{d}O₂, LiNi_{1-d}Mn_{d}O₂ (0≦d<1), Li(NiₓCo_{y}Mn_{z})O₄ (0<x<2, 0<y<2, 0<z<2, x+y+z=2), LiMn₂₋ₙNiₙO₄, LiMn₂₋ₙCoₙO₄ (0<n<2), LiCoPO₄, LiFePO₄, etc., may be used, and preferably, LiCoO₂ is used.

As an anode active material, graphite, carbon, lithium metal and alloy, etc., that are capable of lithium ion intercalation/deintercalation, may be used. Preferably, artificial graphite is used. The anode may comprise a binder, in which the binder is preferably PVDF (Polyvinylidene fluoride) or SBR (Styrene Butadiene Rubber).

As a separator, a porous separator is preferably used. For example, a polypropylene-, a polyethylene- or a polyolefin-based porous separator may be used, but it is not limited thereto.

The electrolyte solution used in the present invention is a non-aqueous electrolyte solution and may comprise a cyclic carbonate and a linear carbonate. The cyclic carbonate includes, for example, ethylene carbonate (EC), propylene carbonate (PC) and gamma-butyrolactone (GBL). Preferably, the linear carbonate includes, for example, at least one carbonate selected from the group consisting of diethyl carbonate (DEC), dimethyl carbonate (DMC), ethylmethyl carbonate (EMC) and methylpropyl carbonate (MPC).

Additionally, the electrolyte solution used in the present invention comprises a lithium salt in addition to the said carbonate compound. Particularly, the lithium salt is preferably selected from the group consisting of LiClO₄, LiCF₃SO₃, LiPF₆, LiBF₄, LiAsF₆ and LiN(CF₃SO₂)₂. The lithium secondary cell according to the present invention is manufactured by a conventional method, i.e., by inserting a porous separator between a cathode and an anode and introducing an electrolyte solution.

Preferably, the lithium secondary cell according to the pre set invention has the shape of a cylindrical can, an angular cell or a pouch.

### BRIEF DESCRIPTION OF THE DRAWINGS

FIG. 1 is a structural model of a layered structure of the additive for a cathode active material represented by formula 1, before charge.

FIG. 2 is a structural model of a spinel structure of the additive for a cathode active material represented by formula 2, after initial charge/discharge.

FIG. 3 is a graph showing the result of a structural analysis of the additive for a cathode active material represented by formula 1, by X-ray diffraction.

FIG. 4 is a graph showing the result of a structural analysis by X-ray diffraction, before and after a charge/discharge test of a coin type cell, when the lithium manganese oxide of formula 1 having a layered structure was used as an additive for a cathode active material.

FIG. 5 is a curve showing the current and the cell voltage according to a charge/discharge test of the cell using the additive for a cathode active material according to the present invention.

FIG. 6 is a graph showing the cell capacity test results of initial 50 charge/discharge cycles, when the lithium manganese oxide having a layered structure represented by formula 1 is used as an additive for a cathode active material in a coin-type cell.

FIG. 7 is a graph showing the cathode potential and the anode potential, before and after using the additive for a cathode active material according to the present invention.

FIG. 8 is a diagram showing the over-discharge test results of the following Example 1 and Comparative Example 1.

FIG. 9 is a graph showing a full cell voltage during the over-discharge test of Comparative Example 1.

FIG. 10 is a graph showing a full cell voltage during the over-discharge test of Example 1.

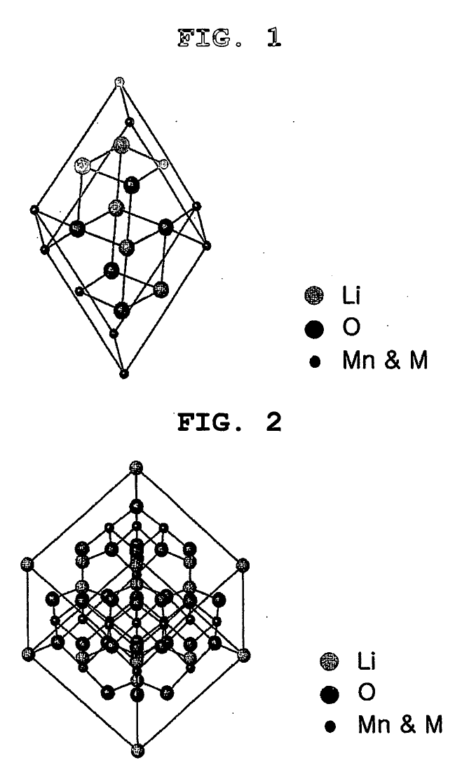

### BEST MODE FOR CARRYING OUT THE INVENTION

Reference will now be made in detail to the preferred embodiments of the present invention. It is to be understood that the following examples are illustrative only and the present invention is not limited thereto.

### Example 1

A pouch-type polymer cell of 383562 size was manufactured by a conventional method.

LiCoO₂ was used as a cathode active material and LiCr_{0.1}Mn_{0.9}O₂ was added in the amount of 8 parts by weight based on 100 parts by weight of the cathode active material.

LiCr_{0.1}Mn_{0.9}O₂ was prepared by mixing lithium carbonate, manganese oxide and chrome oxide in solid phases, heat-treating the mixture at a temperature of 1000° C. under argon atmosphere for 12 hours, pulverizing the heat-treated mixture and further heat-treating the pulverized mixture at a temperature of 1100° C. under argon atmosphere for 12 hours.

Additionally, Super-p and PVDF polymer, used as a conductive agent and a binder, respectively, were added to NMP as a solvent to form cathode mixture slurry, and then the slurry was coated on an Al collector to obtain a cathode. On the other hand, artificial graphite and copper were used as an anode active material and an anode collector, respectively, and an EC/PC/DEC-based electrolyte solution containing 1M LiPF₆ was used to obtain a cell by a conventional method.

### Comparative Example 1

Example 1 was repeated to obtain a cell, except that the additive for a cathode active material (LiCr_{0.1}Mn_{0.9}O₂) was not used in the cathode.

### Experimental Example 1

FIG. 3 is a graph showing the result of a structural analysis of the lithium manganese oxide, LiCr_{0.1}Mn_{0.9}O₂, used as an additive for a cathode active material in Example 1 by X-ray diffraction. According to FIG. 3, it is apparent that the lithium manganese oxide of formula 1 is a compound having a layered structure.

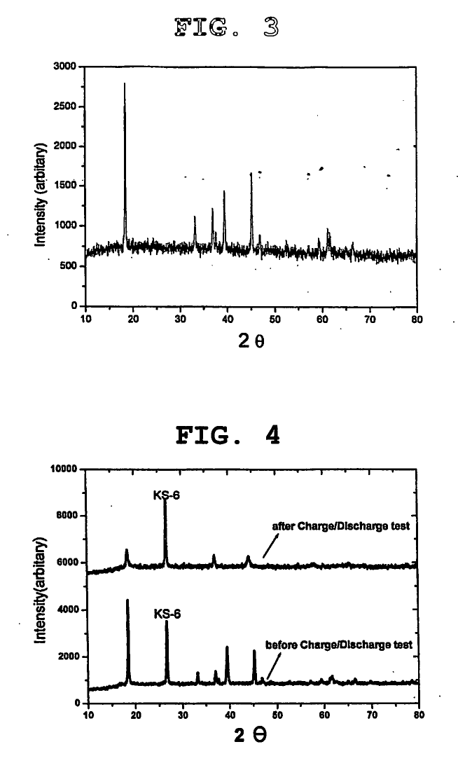

On the other hand, as shown in FIG. 4, the lithium manganese oxide having a layered structure, LiCr_{0.1}Mn_{0.9}O₂, was structurally changed into a spinel structure, after a coin-type cell obtained by using the same compound as an additive for a cathode active material experienced initial charge/discharge.

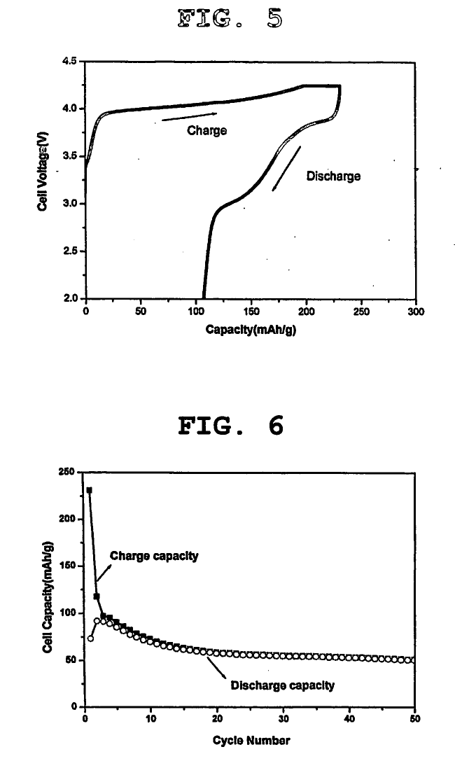

Additionally, as demonstrated in FIG. 5 showing the first charge/discharge capacity of a coin-type cell obtained by using the lithium manganese oxide of formula 1 having a layered structure as an additive for a cathode active material, the cell provided a very low first charge/discharge efficiency. As demonstrated in FIG. 6 showing the charge capacity and the discharge capacity in the initial 50 charge/discharge cycles, the lithium manganese oxide provided a very low first charge/discharge efficiency. However, a charge/discharge efficiency of about 100% could be obtained in the following charge/discharge cycles, and thus reversible lithium intercalation/deintercalation could occur.

### Experimental Example 2

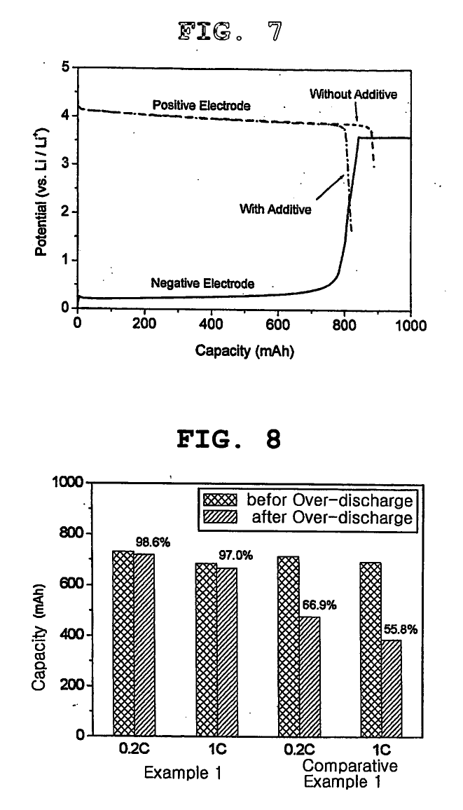

A charge capacity and a discharge capacity before and after an over-discharge test were determined using each of the pouch-type polymer cells of 383562 size obtained from Example 1 and Comparative Example 1, through a conventional method. The over-discharge test results are shown in FIG. 8. Each of the numbers means a discharge capacity restorability at 0.2C and 1C after over-discharge, based on a discharge capacity at 0.2 C and 1 C before over-discharge. As shown in FIG. 8, Example 1 according to the present invention provided a discharge capacity restorability of 90% or more after an over-discharge test, and thus provided an excellent over-discharge preventing effect compared to Comparative Example 1.

### Experimental Example 3

In order to demonstrate the effect of the additive for a cathode active material on over-discharge, a three-electrode experiment was performed using the cells of Example 1 and Comparative Example 1. A base electrode (reference electrode) made of lithium metal was inserted to each of the pouch-type polymer cells of 383562 size obtained from Example 1 and Comparative Example 1. Then, the potential differences between the reference electrode and each of the cathode and the anode were measured in order to check how the cathode potential based on the base electrode and the anode potential based on the base electrode were changed in a practical cell during charge/discharge cycles.

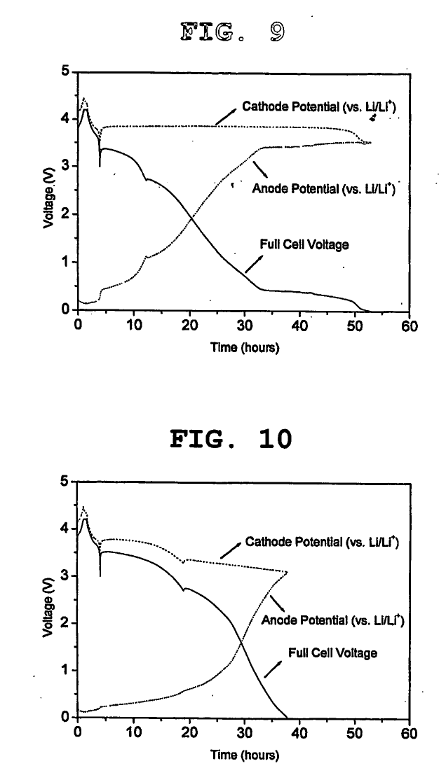

In the case of Comparative Example 1, the anode voltage increased during an over-discharge test and a plateau in which copper ions were dissolved out was present, as can be seen from FIG. 9. On the other hand, in the case of Example 1, a plateau in which copper ions were dissolved was not present, as can be seen from FIG. 10.

Therefore, according to the present invention, LiCr_{0.1}Mn_{0.9}O₂ providing a large irreversible capacity at the first charge/discharge cycle is added in order to control the irreversible capacities of the cathode and the anode adequately, and thus it is possible to prevent the increase of the anode voltage in an over-discharge test so that the cell capacity may not be significantly reduced after the over-discharge test.

### INDUSTRIAL APPLICABILITY

As can be seen from the foregoing, according to the present invention, the compound of formula 1, preferably LiCr_{0.1}Mn_{0.9}O₂, is added to a cathode as an additive for a cathode active material to improve over-discharge properties, and the additive for a cathode active material can provide lithium ions in such an amount as to compensate for the irreversible capacity of an anode, or more. Accordingly, the anode voltage can be prevented from increasing during an over-discharge test so that a cell capacity restorability of 90% or more may be obtained after the over-discharge test.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A cathode active material for a lithium secondary cell comprising a lithium-transition metal oxide capable of lithium ion intercalation/deintercalation, characterized by further comprising a lithium manganese oxide having a layered structure represented by the following formula 1 as an additive:
LiMₓMn₁₋ₓO₂ [formula 1]
wherein, x is a number satisfying 0.05≦x<0.5, and M is at least one metal selected from the group consisting of Cr, Al, Ni, Mn and Co.

2. The cathode active material according to claim 1, wherein the content of the lithium manganese oxide having a layered structure is 1 to 50 parts by weight based on 100 parts by weight of the lithium-transition metal oxide.

3. The cathode active material according to claim 1, wherein the lithium manganese oxide having a layered structure is LiCr_{0.1}Mn_{0.9}O₂.

4. The cathode active material according to claim 1, wherein the lithium manganese oxide is at lest one material selected from the group consisting of: LiCoO₂, LiNiO₂, LiMnO₂, LiMn₂O₄, Li(NiₐCo_{b}Mn_{c})O₂, LiNi_{1-d}Co_{d}O₂, LiCo_{1-d}Mn_{d}O₂, LiNi_{1-d}Mn_{d}O₂, Li(NiₓCo_{y}Mn_{z})O₄, LiMn₂₋ₙNiₙO₄, LiMn₂₋ₙCoₙO₄, LiCoPO₄ and LiFePO₄, wherein 0<a<1, 0<b<1, 0<c<1, a+b+c=1, 0≦d<1, 0<x<2, 0<y<2, 0<z<2, x+y+z=2, and 0<n<2.

5. A lithium secondary cell comprising a cathode, an anode, a separator, and a non-aqueous electrolyte solution containing a lithium salt and an electrolyte compound, wherein the cathode comprises a cathode active material comprising a lithium-transition metal oxide capable of lithium ion intercalation/deintercalation and a lithium manganese oxide having, a layered structure represented by the following formula 1 as an additive:
LiMₓMn₁₋ₓO₂ [formula 1]
wherein, x is a number satisfying 0.05≦x<0.5, and M is at least one metal selected from the group consisting of Cr, Al, Ni, Mn and Co.

6. The lithium secondary cell according to claim 5, wherein the lithium manganese oxide having a layered structure represented by the following formula 1, which is contained in the cathode active material, is changed into a lithium manganese oxide having a spinel structure represented by the following formula 2 by the first charge/discharge cycle of the lithium secondary cell:
LiMₓMn₁₋ₓO₂ [formula 1]
LiM₂ₓMn₂₋₂ₓO₄ [formula 2]
wherein, x is a number satisfying 0.05≦x<0.5, and M is at least one metal selected from the group consisting of Cr, Al, Ni, Mn and Co.

7. The lithium secondary cell according to claim 5, wherein the lithium salt is at least one selected from the group consisting of LiClO₄, LiCF₃SO₃, LiPF₆, LiBF₄, LiAsF₆ and LiN(CF₃SO₂)₂, and the electrolyte compound is at least one carbonate selected from the group consisting of ethylene carbonate (EC), propylene carbonate (PC), gamma-butyrolactone (GBL), diethyl carbonate (DEC), dimethyl carbonate (DMC), ethylmethyl carbonate (EMC) and methylpropyl carbonate (MPC).

8. The lithium secondary cell according to claim 5, wherein the content of the lithium manganese oxide having a layered structure is 1 to 50 parts by weight based on 100 parts by weight of the lithium-transition metal oxide.

9. The lithium secondary cell according to claim 5, wherein the lithium manganese oxide having a layered structure is LiCr_{0.1}Mn_{0.9}O₂.

10. The lithium secondary cell according to claim 5, wherein the lithium manganese oxide is at lest one material selected from the group consisting of: LiCoO₂, LiNiO₂, LiMnO₂, LiMn₂O₄, Li(NiₐCO_{b}Mn_{c})O₂, LiNi_{1-d}CO_{d}O₂, LiCo_{1-d}Mn_{d}O₂, LiNi_{1-d}Mn_{d}O₂, Li(NiₓCo_{y}Mn_{z})O₄, LiMn₂₋ₙNiₙO₄, LiMn₂₋ₙCoₙO₄, LiCoPO₄ and LiFePO₄, wherein 0<a<1, 0<b<1, 0<c<1, a+b+c=1, 0<1, 0<x<2, 0<y<2, 0<z<2, x+y+z=2, and 0<n<2.
